(19) United States
(12) Patent Application Publication
(10) Pub. No.: US 2014/0347235 A1
(43) Pub. Date: Nov. 27, 2014

(54) ANTENNA POSITIONING DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: YONG-SHENG YANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/223,969

(22) Filed: Mar. 24, 2014

(30) Foreign Application Priority Data
May 23, 2013 (CN) 2013101981999

(51) Int. Cl. H01Q 3/04

(52) U.S. Cl. CPC H01Q 3/04
USPC 343/760

(57) ABSTRACT

An antenna positioning device includes a mast, a height measuring device, a distance measuring device, a controller, a power device, an elevator and an antenna fixed on the elevator. The height measuring device measures a height of test equipment. The distance measuring device measures a distance between the center of the antenna and the test equipment. The controller calculates a coverage width of the antenna, and controls the power device to drive the elevator to move along the mast until the antenna is located at a half of the height of the test equipment if the coverage width is greater than or equal to the height of the test equipment, and control the power device to drive the elevator to move along the mast until the antenna is located at the top of the test equipment if the coverage width is less than the height of the test equipment.

### BACKGROUND

1. Technical Field

The present disclosure relates to an antenna positioning device.

2. Description of the Related Art

According to test regulations, a testing of an electromagnetic wave of a test equipment via a horn antenna, the horn antenna should be located at the top of test equipment when the overage width of the horn antenna is less than the height of the test equipment. In addition, the horn antenna should be located at a half of the height of test equipment when the overage width of the horn antenna is greater than or equal to the height of the test equipment. Conventionally, the height of horn antenna is manually adjusted, which is often inconvenient.

### BRIEF DESCRIPTION OF THE DRAWING

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a simple isometric view of antenna positioning device, according to an embodiment.

FIG. 2 is a block diagram of a controller of the antenna positioning device in FIG. 1.

FIG. 3 is a simple isometric view of an elevator of the antenna positioning device in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

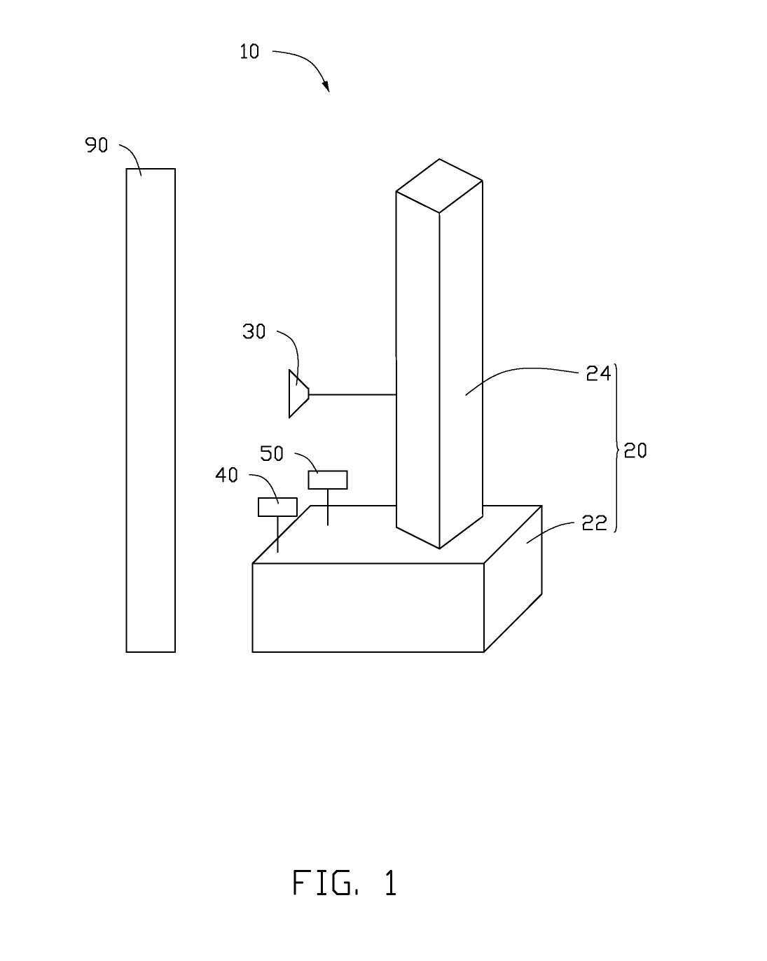

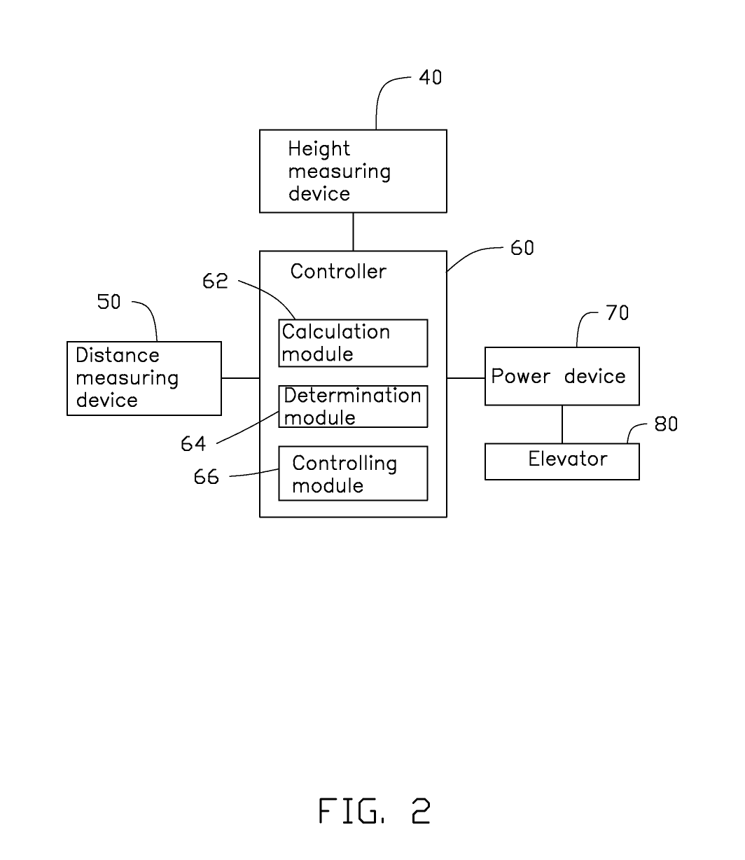

FIGS. 1 and 2 show an antenna positioning device 10 of an illustrated embodiment. The antenna positioning device 10 includes a frame 20, a height measuring device 40, a distance measuring device 50, a controller 60, a power device 70, and an elevator 80. The height measuring device 40, the distance measuring device 50 and the power device 70 are electrically connected to the controller 60. The power device 70 is mechanically connected to the elevator 80 and configured to drive the elevator 80 to move up and down.

The frame 20 includes a base 22 and a mast 24 fixed to the base 22. The height measuring device 40 and the distance measuring device 50 are both fixed on the base 22. The controller 60 and the power device 70 are both fixed in the base 22. The elevator 80 is positioned in the mast 24 and movable along the mast 24. A horn antenna 30 is fixed to the elevator 80, thus the horn antenna 30 is movable up and down following the movement of the elevator 80.

The controller 60 includes a calculation module 62, a determination module 64 and a control module 66. The height measuring device 40 is configured to measure the height of test equipment 90 and send the measured height to the determination module 64. The distance measuring device 50 is configured to measure a distance between the center of the horn antenna 30 and the test equipment 90 and send the measured distance to the calculation module 62. The calculation module 62 is configured to calculate a coverage width of the horn antenna 30 according to the measured distance and an opening angle of the horn antenna 30. A calculation formula is W=2*L*tgY/2, wherein W represents the coverage width of the horn antenna 30, L represents the measured distance, Y represents the opening angle of the horn antenna 30. The determination module 64 is configured to determine whether the coverage width of the horn antenna 30 is less than the height of the test equipment 90. If the overage width of the horn antenna 30 is less than the height of the test equipment 90, the control module 66 controls the power device 70 to drive the elevator 80 to move along the mast 24 until the horn antenna 30 is located at the top of test equipment 90. If the overage width of the horn antenna 30 is greater than or equal to the height of the test equipment 90, the control module 66 controls the power device 70 to drive the elevator 80 to move along the mast 24 until the horn antenna 30 is located at a half of the height of test equipment 90.

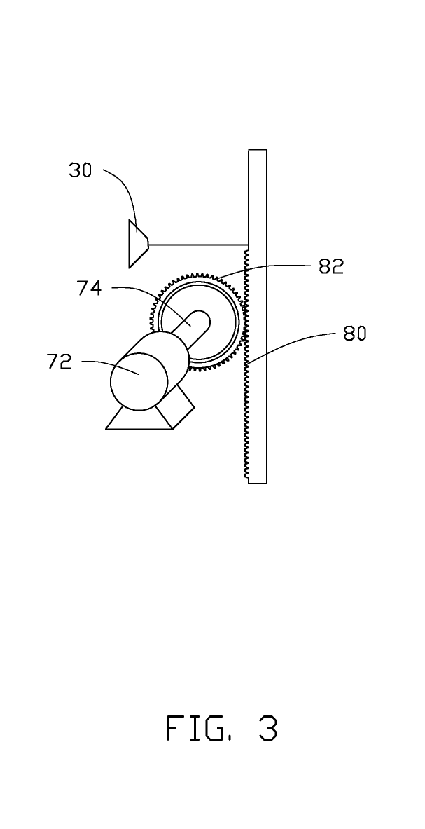

FIG. 3 shows that in the embodiment, the power device 70 is a stepper motor 72. The stepper motor 72 includes an output shaft 74. The elevator 80 includes a gear 82 and a rack 84. The gear 82 sleeves on the output shaft 74. One end of the rack 84 is engaged in the gear 82 and the other end of the rack 84 is fixed to the horn antenna 30. The control module 66 controls the stepper motor 72 to turn clockwise or anticlockwise corresponding laps moving the gear 82 and rack 84 until the horn antenna 30 is located at corresponding position to test the test equipment 90.

In an embodiment, the height measuring device 40 is a laser altimeter. The distance measuring device 50 is a laser rangefinder. The distance measuring device 50 is positioned below the center of the horn antenna 30.

The antenna positioning device 10 controls the horn antenna 30 to move to corresponding position according to the overage width of the horn antenna 30. Thus, the horn antenna 30 is automatically positioned.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An antenna positioning device comprising:
a frame comprising a mast;
an elevator movable along the mast;
a power device mechanically connected to the elevator and configured to drive the elevator to move up and down;
a horn antenna fixed to the elevator;
a height measuring device configured to measure the height of a test equipment and send the measured height;
a distance measuring device configured to measure a distance between the center of the horn antenna and the test equipment and send the measured distance; and
a controller comprising:
a calculation module configured to calculate a coverage width of the horn antenna according to the measured distance and an opening angle of the horn antenna;
a determination module configured to determine whether the coverage width of the horn antenna is less than the measured height; and
a control module configured to control the power device to drive the elevator to move along the mast until the horn antenna located at the top of test equipment if the overage width of the horn antenna less than the height of the test equipment and control the power device to drive the elevator to move along the mast until the horn antenna located at a half of the height of the test equipment if the overage width of the horn antenna greater than the height of the test equipment.

2. The antenna positioning device as claimed in claim 1, wherein the power device is a stepper motor, the stepper motor comprises an output shaft, the elevator comprises a gear and a rack, the gear sleeves on the output shaft, one end of the rack is engaged with the gear and an opposite end of the rack is fixed to the horn antenna, and the control module configured to control the stepper motor to turn clockwise or anticlockwise corresponding laps moving the gear and rack until the horn antenna is located at the top of test equipment or located at a half of the height of the test equipment.

3. The antenna positioning device as claimed in claim 1, wherein the frame further comprises a base, the mast, the height measuring device and the distance measuring device are fixed on the base, and the controller and the power device are fixed in the base.

4. The antenna positioning device as claimed in claim 1, wherein the height measuring device is a laser altimeter.

5. The antenna positioning device as claimed in claim 1, wherein the distance measuring device is a laser rangefinder, and the distance measuring device is positioned below the center of the horn antenna.

6. An antenna positioning device comprising:
a bracket comprising a supporting shaft;
an elevator movable along the supporting shaft;
a power device mechanically connected to the elevator and configured to drive the elevator to move back and forth;
a horn antenna fixed to the elevator;
a measuring device configured to measure the height of a test equipment and a distance between the center of the horn antenna and the test equipment;
a controller comprising:
a calculation module configured to calculate a coverage width of the horn antenna according to the measured distance and an opening angle of the horn antenna;
a determination module configured to determine whether the coverage width of the horn antenna is less than the measured height of the test equipment; and
a control module configured to control the power device to drive the elevator to move along the supporting shaft until the horn antenna positioned at the top of test equipment if the overage width of the horn antenna less than the height of the test equipment and control the power device to drive the elevator to move along the supporting shaft until the horn antenna positioned at a half of the height of the test equipment if the overage width of the horn antenna greater than the height of the test equipment.

7. The antenna positioning device as claimed in claim 6, wherein the power device is a stepper motor, the stepper motor comprises an output shaft, the elevator comprises a gear and a rack, the gear is installed to the output shaft, one end of the rack is engaged with the gear and an opposite end of the rack is fixed to the horn antenna, and the control module configured to control the stepper motor to turn clockwise or anticlockwise corresponding laps moving the gear and rack until the horn antenna is positioned at the top of test equipment or positioned at a half of the height of the test equipment.

8. The antenna positioning device as claimed in claim 6, wherein the bracket further comprises a base, the supporting shaft, the height measuring device and the distance measuring device are all fixed on the base, and the controller and the power device are fixed in the base.

9. The antenna positioning device as claimed in claim 6, wherein the height measuring device is a laser altimeter.

10. The antenna positioning device as claimed in claim 6, wherein the measuring device is a laser rangefinder, and the measuring device is positioned below the center of the horn antenna.
